(19) United States
(12) Patent Application Publication
(10) Pub. No.: US 2014/0307425 A1
(43) Pub. Date: Oct. 16, 2014

(54) SOLAR TREE ORNAMENT

(71) Applicant: Cynthia Price, Keene, NH (US)

(72) Inventor: Cynthia Price, Keene, NH (US)

(21) Appl. No.: 14/180,642

(22) Filed: Feb. 14, 2014

Related U.S. Application Data
(60) Provisional application No. 61/853,720, filed on Apr. 11, 2013.

(51) Int. Cl. F21L 4/08; F21V 33/00

(52) U.S. Cl. CPC F21L 4/08; F21V 33/0004
USPC 362/183

(57) ABSTRACT

A solar powered ornament for suspending on a tree is disclosed. The solar powered ornament contains at least one solar energy gatherer that converts solar energy to electrical energy. One or more batteries are also included to store electrical energy. A light sensor or a photoresistor detects ambient light to turn on lamps placed inside the solar powered ornament. The solar powered ornament is operated individually allowing independent placement of the solar powered ornament for decorative purposes.

### CROSS-REFERENCE TO RELATED APPLICATIONS

This application is a non-provisional application which claims the benefit to Provisional Application No. 61/853,720 filed on Apr. 11, 2013.

### BACKGROUND OF THE INVENTION

1. Field of the Invention

The present invention relates generally to the field of outdoor lighting and decoration for holiday, special occasions, and everyday display. More particularly, a suspending display ornament for decorative purposes.

2. Description of Related Art

Placing light and decorations on trees, bushes, and other items are a popular choice for decorating the exterior of homes or businesses. For instance, conventional lighting and decor often are string lights where many lights are strung together. As such, placements of string lights are limited and cumbersome. On the other hand, some solar powered lightings and decorations are used for many things, such as path markers, fencepost toppers, embedded in figurines, none of which are suitable for suspension.

Therefore a need exists for a lighted ornament which provides ease in manufacture, simple installation at user's discretion without limitation due to wiring or other connecting elements.

### SUMMARY OF THE INVENTION

The subject matter of this application may involve, in some cases, interrelated products, alternative solutions to a particular problem, and/or a plurality of different uses of a single system or article.

The present invention relates to an improvement and simplification in outdoor solar powered ornaments. Ornaments may be used during holiday seasons, special occasions, or everyday display, to decorate trees, bushes, and/or other outdoor items. These ornaments may have any decorative forms. The ornaments are not strung together, therefore are independent. Each ornament can be placed close together, far apart, and in any location and number desired. They are solar powered thus eliminating use of wiring of predetermined length and spacing.

Accordingly, it is the object of the present invention to provide individual suspending solar powered ornaments not limited in placement due to predetermined length, spacing, and quantity.

In one aspect, a suspension display ornament is provided. The suspension display ornament comprises a body defining a cavity formed therein. Further, the suspension display ornament comprises a solar energy gatherer, a photoresistor, a light source, a battery, and a hanger. The solar energy gatherer may be mounted on an outer surface of the body it may collect light energy and convert the light energy to electric energy.

The photoresistor may be mounted on the outer surface of the body and may detect ambient light surrounding the suspension display ornament. This may allow the ornament to turn on when it is dark out (low ambient light) and collect and store light energy when it is bright out (high ambient light). The light source may be electrically connected to the photoresistor and placed within the cavity. The battery may store the converted electric energy and provide electric energy to the light source. Finally, a hanger may be formed within the body to suspend the body.

### BRIEF DESCRIPTION OF THE DRAWINGS

FIG. 1 provides an embodiment of a suspension display ornament.

FIG. 2 provides another embodiment of the suspension display ornament illustrating etching and an aperture as a hanger.

FIG. 3 provides yet another embodiment of the suspension display ornament.

FIG. 4 provides a cross-sectional view of an embodiment of the suspension display ornament.

FIG. 5 provides another embodiment of the suspension display ornament with a plurality of opening formed on the body.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a solar-powered suspension display ornament. Unlike conventional display ornaments, the present invention achieves both low power consumption and versatility in arranging the individual ornaments.

In a preferred embodiment, the suspension display ornament may comprise a body defining a cavity formed therein, a solar energy gatherer that converts solar energy to electrical energy, necessary circuitry extending from the solar energy gatherer to at least one battery, a hanger to allow suspension of the suspension display ornament, and at least one photoresistor.

The solar gatherer contemplated herein may be photovoltaic cells, solar panels, and the like. In some embodiments, the solar gatherer may be flexible so as to be mounted on an outer surface of the body. The photoresistor contemplated herein may be any types of light dependent resistors.

The suspension display ornament may further comprise a light source. The light source may be placed within the cavity of the body. The light emerging from the light source will enhance the shape, color, decor of the ornament. The light source may be electrically connected to the photoresistors and the battery. In some embodiments, this may aid in avoiding dark spots in a display set up.

In one embodiment, the suspension display ornament may contain a plurality of light sources of different colors within the cavity of the body. Each of the plurality of light sources may be placed at various angles emitting light in various directions to maximize the amount of light being scattered inside the cavity. In another embodiment, the suspension display ornament may further comprise a switching device which controls the operation of each of the plurality of light sources. Light may escape from the cavity either via a transparent or translucent body material (either a portion or the entire body), or may escape through one or a plurality of apertures forming openings in the body. These apertures may be open, or may be covered with a transparent or translucent material.

The light sources contemplated herein may include, but are not limited to incandescent or fluorescent lamps, light emitting diodes, color light emitting diodes, and the like.

The battery contemplated herein may be various types of energy storage devices, which may include, but are not limited to lithium-ion, nickel-cadmium or other suitable rechargeable batteries.

In one embodiment, the suspension display ornaments may be fabricated by a number of manufacturing processes known to those of ordinary skill in the art, including, but not limiting to injection molding, vacuum forming, die casting, extruding, manual or computerized, drilling , sawing, chemical etching by solution, sand blasting, engraving, or any other technique known in the art. In another embodiment, the suspension display ornament may be manufactured by molding thermoplastic or any other moldable materials into any shape, size, or form, wherein the hanger may be placed at desired location for hanging. The hanger may be a loop, an aperture formed within the body, and the like.

The body of the suspension display ornament may be of various materials, including, but are not limited to, ABS, acrylic, polypropylene, phenolic resins, amino resins, transparent materials, translucent materials, or other suitable materials. The material of the body may be of any colors or combination of colors. In one embodiment, custom color may be applied to the body by tinting the material prior to manufacturing.

The suspension display ornament may further comprise a light scattering medium. The light scattering medium may be embedded into or placed on the body to create a further dispersion of light. The light scattering medium improves lighting characteristics of the suspension display ornament, in spite of the use of low power consumption.

In one embodiment, the light scattering medium may be that of etching on the body. The etching may be done very lightly or aggressively; in various sizes and widths; or at one side or numerous sides of the body.

In another embodiment, the light scattering medium may be made of various light reflecting and scattering materials, such as glitter, aluminum, stainless steel, or the like. In a further embodiment, a mirror like coating or reflective material may be placed on the suspension display ornament during or after manufacturing having various textures that reflects and/or dispenses light.

In yet another embodiment, the light scattering medium may be reflective flecks. The reflective flecks may be disposed within the body of the suspension display ornament, creating a dispersion of the light.

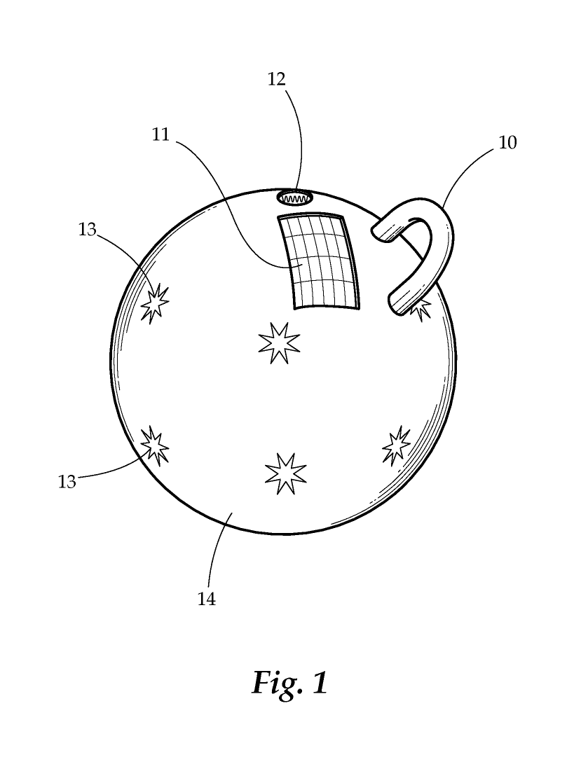

Turning now to FIG. 1, an embodiment of a suspension display ornament is shown. The suspension display ornament comprises a hanger 10, a photoresistor 12, a solar gatherer 11, and apertures 13. The hanger forms a loop allowing suspensions of the body 14. Once light is collected by the solar gatherer, it is converted into electric energy. A battery (not shown) may be placed within a cavity of the body to store the converted electric energy. The apertures 13 disperse light emitting from a light source (not shown) within the cavity of the suspension display ornament.

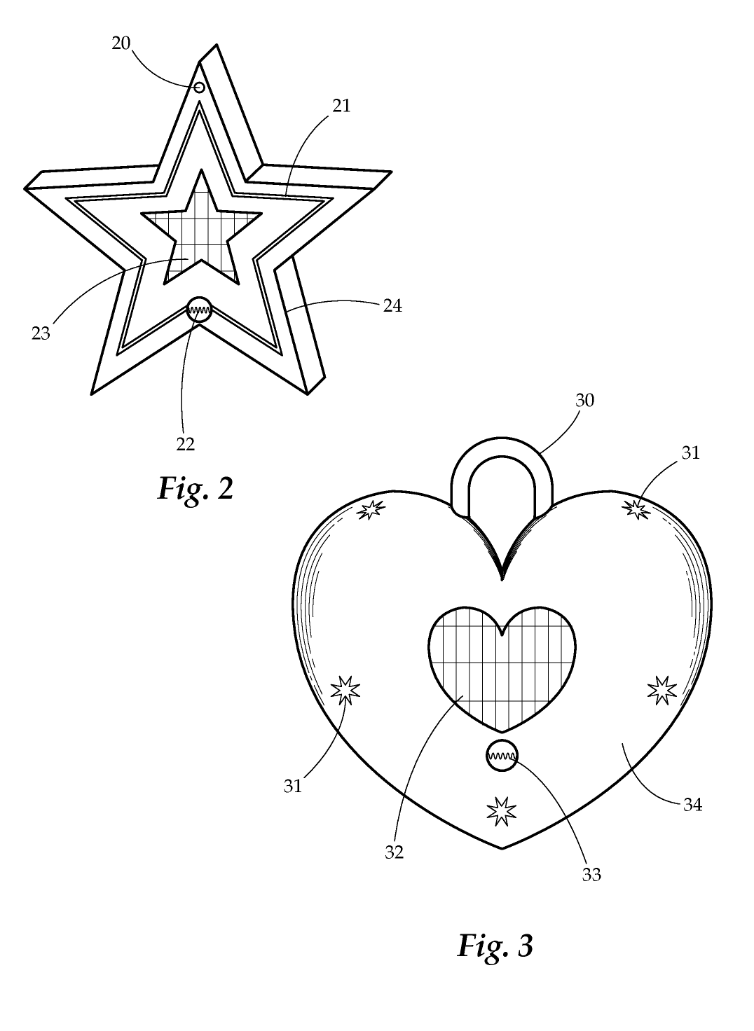

FIG. 2 shows another embodiment of the suspension display ornament illustrating etching and an aperture as the hanger. In this embodiment, the aperture 20 is formed by the body 24. The aperture 20 may be utilized for suspending the body 24. An etching 21 is formed along the periphery of the body 24, allowing reflection of light emitted to and from the suspension display ornament. A photoresistor 22 is shown. A solar gatherer 23 is shown having a shape similar to the design of the body 24 which enhances function of the suspension display ornament. In operation, the photoresistor 22 is configured to activate a light source when it measured low ambient light conditions. This photoresistor 22 is further configured to deactivate the light source when it measures high ambient light conditions. The solar gatherer 23 gathers solar energy, converts it to electricity, and then stores this electricity in a battery within the cavity of the body 24. The light source is configured to draw power from this batter to emit light. This light may escape from the body cavity either by openings in the body, or transparent/translucent body material that allows light to escape. In this embodiment, the reflective etching on the body surfaces enhances the light scattering of light leaving the cavity, as well as any light coming to the reflective etching from other sources such as a nearby ornament.

FIG. 3 illustrates yet another embodiment of the suspension display ornament. The suspension display ornament comprises a body 34 wherein a solar gatherer 32 is placed at the center of the body 34 configured to receive light energy and convert the light energy to electric energy. A photoresistor 33 is mounted on the outer surface of the body 34 wherein the photoresistor 33 detects ambient light. A hanger 30 is placed at one end of the body 34 allowing suspension of the body 34. A plurality of light scattering medium enables further dispersion of the light coming out of or to the body. In this embodiment, the plurality of light scattering medium is represented with a plurality of reflective metals 31. Each of the plurality of reflective metals 31 are placed on the periphery of the body 34.

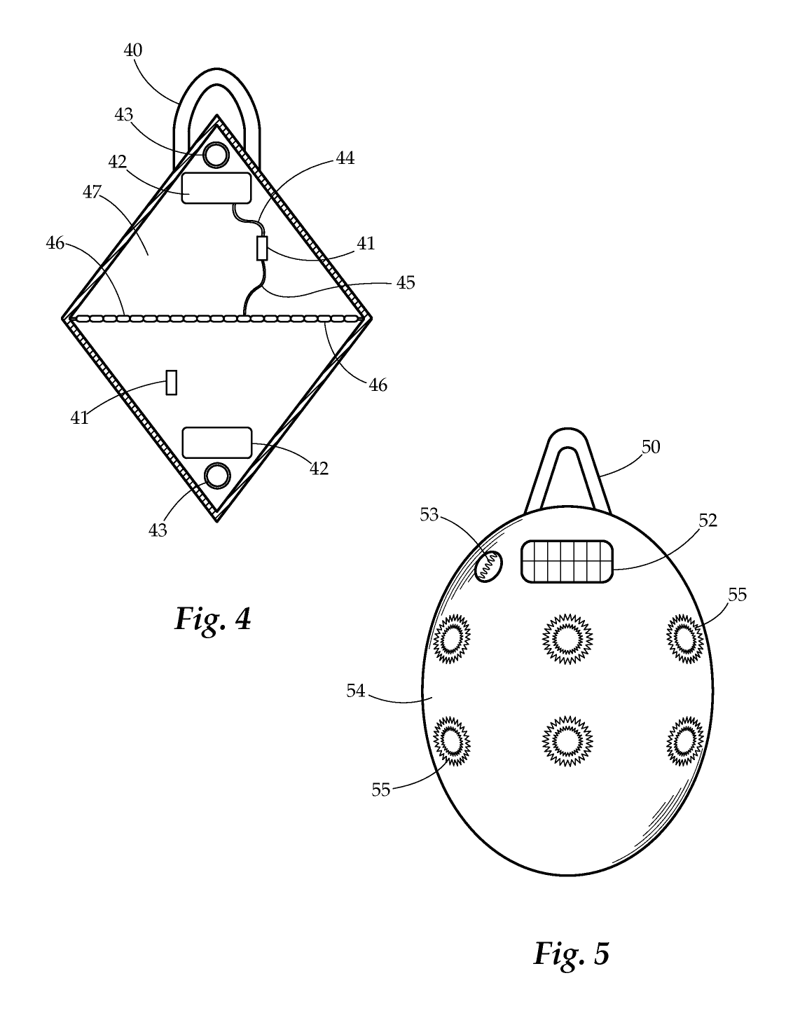

FIG. 4 shows a cross-sectional view of an embodiment of the suspension display ornament. FIG. 4 illustrates components of the suspension display ornament placed within the body cavity 47. The components comprises a pair of photoresistors 43 configured to measure ambient light an deactivate a light source 46, a pair of solar gatherers 42, a pair of batteries 41, a plurality of light sources 46, and wires 41 electrically connecting the solar gatherers 42, and the batteries 41. The plurality of light sources 46 are shown here about a middle width of the suspension display ornament, but it should be understood that the light sources may be positioned anywhere within the cavity, and may be a single light source, or a plurality. The photoresistor 43 detects ambient light around the suspension display ornament. Once light is emitted to the solar gatherer the light energy is converted to electric energy and the electric energy is stored in the batteries. The electric energy stored in the batteries 41 provides energy to the plurality of light sources. The photoresistor 43 reacts to the ambient light controlling the operation of each of the plurality of light sources.

FIG. 5 provides another embodiment of the suspension display ornament with a plurality of openings formed on the body. In this embodiment, the suspension display ornament comprises a hanger 50 formed on one end of the body 54, a solar gatherer 52 configured to collect light energy and convert the light energy to electric energy, a photoresistor 53, and a plurality of openings 55. Each of the plurality of opening 55 exposes the cavity of the body 54. In one embodiment, a plurality of light sources (not shown) may be placed within the cavity of the body where the light produced from each of the plurality of light sources emits through each of the plurality of openings.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A suspension display ornament comprising:
a body defining a cavity formed therein;
a solar energy gatherer mounted on an outer surface of the body, configured to collect light energy and convert the light energy to electric energy;
a photoresistor mounted on the outer surface of the body, configured to detect ambient light;
a light source, electrically connected to and activated or deactivated by the photoresistor, wherein the light source is placed within the cavity;
a battery, electrically connected to the solar energy gatherer, the light source, and the photoresistor, wherein the battery is configured to store electric energy; and
a hanger attached to an exterior of the body and configured to suspend the body.

2. The suspension display ornament of claim 1 further comprising an opening formed on the body exposing the cavity of the body.

3. The suspension display ornament of claim 1 wherein the hanger is formed protruding away from the body.

4. The suspension display ornament of claim 1 wherein the hanger is an aperture formed through the body.

5. The suspension display ornament of claim 1 wherein the solar energy gatherer is flexible.

6. The suspension display ornament of claim 1 wherein the solar energy gatherer is a photovoltaic cell.

7. The suspension display ornament of claim 1 wherein the battery is rechargeable.

8. The suspension display ornament of claim 1 further comprising a light scattering medium attached to the body and configured to disperse light emitted to the light scattering medium.

9. The suspension display ornament of claim 8 wherein the light scattering medium is selected from the group consisting of glitter, reflective metals, and metal flakes.

10. The suspension display ornament of claim 8 wherein the light scattering medium is made of a reflective material.

11. The suspension display ornament of claim 8 wherein the light scattering medium is placed within the cavity.

12. The suspension display ornament of claim 8 wherein the light scattering medium is placed on the periphery of the body.

13. The suspension display ornament of claim 1 wherein the body has at least one of a transparent portion or a translucent portion.

14. The suspension display ornament of claim 1 wherein the light source is selected from the group consisting of lamp bulb, light emitting diode, and color light emitting diode.

15. The suspension display ornament of claim 1 further comprising a plurality of light sources.

16. The suspension display ornament of claim 15 wherein each of the plurality of light sources are placed at an angle such that each of the plurality of light sources emit light in different directions.

17. The suspension display ornament of claim 15 further comprising a switching device electrically connected to each of the plurality of light sources, wherein the switching device controls operation of each of the plurality of light source.

18. The suspension display ornament of claim 17 wherein the switching device is in communication with the photoresistor, and controls operation of each of the plurality of light sources based on an input from the photoresistor.

19. A suspension display ornament comprising:
a body with a cavity formed therein;
a flexible photovoltaic cell mounted on an outer surface of the body, configured to collect light energy and convert the light energy to electric energy;
a photoresistor mounted on the outer surface of the body, configured to detect ambient light;
a plurality of light sources, electrically connected to the photoresistor, each of the plurality of light sources being placed within the cavity, wherein each of the plurality of light sources are placed at an angle such that each of the plurality of light sources emit light in different directions;
an opening formed on the body exposing the cavity of the body;
a switching device electrically connected to each of the plurality of light sources, wherein the switching device controls operation of each of the plurality of light sources;
a rechargeable battery, electrically connected to the solar energy gatherer, wherein the rechargeable battery is configured to store electric energy, the rechargeable battery being electrically connected to each of the plurality of light sources;
a hanger configured to suspend the body; and
a plurality of light scattering media formed on the periphery of the body, each of the plurality of light scattering media being configured to disperse light emitted to each of the plurality of light scattering media, wherein each of the plurality of light scattering media are reflective.

20. A display ornament suspending from a tree comprising:
a body with a cavity formed therein;
a flexible photovoltaic cell mounted on an outer surface of the body, configured to collect light energy and convert the light energy to electric energy;
a photoresistor mounted on the outer surface of the body, configured to detect ambient light;
a plurality of light sources, electrically connected to the photoresistor, each of the plurality of light sources being placed within the cavity, wherein each of the plurality of light sources are placed at an angle such that each of the plurality of light sources emit light in different directions;
an opening formed on the body exposing the cavity of the body;
a switching device electrically connected to each of the plurality of light sources, wherein the switching device controls operation of each of the plurality of light sources;
a rechargeable battery, electrically connected to the solar energy gatherer, wherein the rechargeable battery is configured to store electric energy, the rechargeable battery being electrically connected to each of the plurality of light sources;
a hanger formed on the body wherein the hanger is removably attached to the tree; and
a plurality of light scattering media formed on the periphery of the body, each of the plurality of light scattering media being configured to disperse light emitted to each of the plurality of light scattering media, wherein each of the plurality of light scattering media are reflective.
